(19) United States
(12) Patent Application Publication
(10) Pub. No.: US 2006/0082013 A1
(43) Pub. Date: Apr. 20, 2006

(54) Process for production or treatment of hollow articles

(75) Inventors: Michael Bayer, Thierhaupten (DE); Elmar Hackenspiel, Zusamaltheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/253,347

(22) Filed: Oct. 19, 2005

(30) Foreign Application Priority Data
Oct. 19, 2004 (DE) 10 2004 050 770.8

(51) Int. Cl. B29C 33/40; B29C 33/76; C08J 5/00

(52) U.S. Cl. 264/221; 264/317; 264/331.17; 264/225

(57) ABSTRACT

A process is described for production or treatment of hollow articles. The process comprises using a material which comprises polyolefin waxes prepared using metallocene catalysts and/or which comprises their derivatives, or which is composed of the substances.

The present invention is described in the German priority application No. 102004050770.8, filed 19 Oct. 2004, which is hereby incorporated by reference as is fully disclosed herein.

The present invention relates to a process for production or treatment of hollow articles. The production of moldings from metals via machining and non-machining processes, such as cold forming is known. The plastics industry also uses thermoplastic or thermoset processes to produce moldings. Most shapes can be produced by these processes. However, industry continues to face problems with production of moldings of complex design, in particular hollow moldings with internal undercuts and radii and curves integrated within the molding, because it is difficult—if indeed possible at all—to produce these directly.

Production of these complex moldings therefore frequently makes use of the “sacrificial cores” process, in which a core is first produced, at least one solid is used to coat at least a portion of the core, and then the core is removed chemically or physically.

By way of example DE 39 23 416 A1 describes production of hollow articles composed of fiber-reinforced plastics (FRP) with a thermoplastic matrix. This process first takes a hermetically sealed hollow core composed of a metallic material, the interior of which has been provided in advance with a volatile substance, and jackets the core with the FRP. To harden and compact the FRP, the arrangement is heated. The hollow core is then extracted from the FRP molding. However, this process is suitable only for the manufacture of thermoplastic fiber-composite components. Metal cores are moreover relatively heavy and require high engineering cost for their manufacture and removal. Particularly if chemical methods are used to remove the cores, the process requires provision of appropriate suitable plant with the necessary safety precautions.

The use of “sacrificial” cores based on wax is likewise known from the prior art, and is described by way of example in DE 26 43 128 A1 and DE 42 02 878 A1. However, industry has found that the conventional wax cores have limited mechanical strength, or become mechanically deformed because their hardness is very low. This markedly restricts their possible field of use, because the shaping of many plastics around these cores is attended by marked mechanical stressing—flexible and tensile stressing—of the core material. Relatively large amounts of core material are needed when using these conventional waxes, which are waxes based on carnauba wax, on paraffins, or on natural waxes, because production of dimensionally stable hollow wax cores with low wall thickness is almost impossible in industry. The wax cores mentioned are moreover brittle and, even when heated, are not expandable, a feature essential for modern production processes in the plastics industry. Conventional waxes moreover have to be modified with fillers in order to minimize shrinkage during the transition from liquid to solid. This again impairs important mechanical properties.

The use of gypsum cores is likewise known, for example, from DE 42 02 878 A1. These cores, like metal cores, are relatively heavy and inelastic, and require high engineering costs for their manufacture. Furthermore, once the actual component has been manufactured, they have to be extracted in an acid bath, i.e. appropriate and suitable plant with the necessary safety precautions has to be provided.

DE 39 00 206 A1 describes the use of “sacrificial” cores composed of lithogenic materials, such as chalk, dolomite, kaolin, talc, or quartz. In order to achieve the initial stability necessary, these non-plastic materials are bound using a temporary binder for ceramic compositions based on PVA and on biological swelling agents. According to DE 39 00 206 A1, the stability of the core reduces via exposure to pressure and temperature during the course of the casting process, the result being that the core can be broken down into dust-like components via exposure to a very small force at the end of the casting process, or is claimed to be simply removable via rinsing with water. The finding in practice, however, has been that, in particular for moldings with internal undercuts and radii and curves integrated within the molding, complete removal of core residues requires the use of acids and alkali, which markedly limits the field of use of this process, because in turn appropriate and suitable plant has to be provided with the necessary safety precautions.

One disadvantage common to all of the core materials mentioned is their relatively low elasticity and their low, or total lack of, thermoplasticity. However, industry demands “sacrificial” cores which are readily moldable and shapeable, in order to provide further simplification and rationalization of production of moldings. Capability of the core materials to be used repeatedly is an additional ideal feature. This provides low cost and reduces the amount of waste.

It was therefore an object to provide a process for production and treatment of hollow articles which does not have the disadvantages of the known processes and in particular permits production of moldings of complex design, in particular of hollow-article moldings with internal undercuts and with radii and curves integrated within the molding, and which can be carried out simply on a large industrial scale and can be carried out at low cost. The materials used in the process should permit avoidance of use of substances hazardous to health, in particular of acids and alkalis, the result being that conduct of the process requires no particular safety precautions and requires no design and provision of appropriate and suitable production plant. The materials used in the process should moreover preferably be capable of residue-free removal from the hollow article. The process should moreover be capable of universal use and should not be subject to restriction to the use of a small number of starting materials in relation to the material from which the hollow article is to be formed.

Surprisingly, the above object could be achieved in that the process for production or treatment of the hollow articles uses a material which comprises one or more metallocene polyolefin waxes and/or their derivatives, i.e. which comprises polyolefin waxes prepared using metallocene catalysts and/or which comprises their derivatives, or which is composed of these substances.

Surprisingly, it has also been found that metallocene polyolefin waxes have particularly good suitability as core material for production of non-metallic or metallic hollow articles. It has also been found that the mechanical properties—strength and elasticity—and their thermal properties—low melt viscosity and good casting capability—make these metallocene polyolefin waxes very suitable as starting materials for cores that can withstand mechanical load, such as those necessary for production of fiber-reinforced plastics parts.

It has moreover been found that cores produced from metallocene polyolefin waxes can give residue-free removal from the hollow article either by thermal-flow methods and/or via dissolution using solvent.

The present invention therefore provides a process for production or treatment of hollow articles which uses a material which comprises one or more metallocene polyolefin waxes and/or their derivatives, or which is composed of these substances.

The inventive process preferably uses a material composed of
a) metallocene polyolefin wax and/or derivatives thereof, preferably metallocene polyolefin wax,
b) if appropriate, up to 99.9% by weight of another wax or resin,
c) if appropriate, up to 20% by weight of an antioxidant,
d) if appropriate, up to 50% by weight of a pulverulent filler insoluble in the metallocene polyolefin wax, and
e) if appropriate, up to 20% by weight of a colorant substance, e.g. a pigment or a soluble dye.

The inventive process for production of the hollow articles preferably includes the following steps:
i) molding of a core composed of a material comprising or composed of one or more metallocene polyolefin waxes and/or their derivatives, and
ii) applying one or more solids to at least a portion of the core.

The hollow articles produced via the inventive process have preferably been selected from hollow metallic components, fiber- or particle-reinforced plastics parts, and metal-casting molds.

In one particularly preferred embodiment of the inventive process, fiber- or particle-reinforced plastics are produced, and the material comprising or composed of one or more metallocene polyolefin waxes and/or their derivatives is expandable. In this embodiment, an example of a possible effect of the expansion of the core material is that the fiber- or particle-reinforced plastics parts become impressed into an outer mold during their production.

In another particularly preferred embodiment of the inventive process, hollow metallic components are produced, and in this process the material comprising or composed of one or more metallocene polyolefin waxes and/or their derivatives serves as binder for production of conductive coatings. In this embodiment, therefore, by way of example, the core material is first provided with a conductive coating and then the metal layer is applied to this conductive coating.

In another particularly preferred embodiment of the inventive process, metal-casting molds are produced, and in this process the material comprising or composed of one or more metallocene polyolefin waxes and/or their derivatives is coated via immersion in a flame-retardant molding composition, which is hardened and is subsequently fired.

In another preferred embodiment of the inventive process, in particular during production of fiber- or particle-reinforced plastics parts, the one or more metallocene polyolefin waxes and/or their derivatives are used together with at least one other substance selected from naturally occurring or synthetic waxes and naturally occurring or synthetic resins.

The inventive process for treatment of the hollow articles preferably includes the following steps:
i) filling of the hollow article with a material comprising or composed of one or more metallocene polyolefin waxes and/or their derivatives, and
ii) treatment of the stored hollow article.

The treatment of the hollow articles by the inventive process is preferably mechanical treatment.

One advantage of the inventive process for treatment of the hollow articles is that the hollow articles are stabilized via the core material during mechanical treatment. Stabilization with respect to vibration is particularly preferred.

In a preferred method for working the inventive process for production or treatment of the hollow articles, the material comprising or composed of one or more metallocene polyolefin waxes and/or their derivatives is in turn removed from the hollow articles after the production or the treatment of the hollow articles.

The inventive process for production of the hollow articles therefore particularly preferably includes the following steps:
i) molding of a core composed of a material comprising or composed of one or more metallocene polyolefin waxes and/or their derivatives,
ii) applying one or more solids to at least a portion of the core, and
iii) removal of the core material.

The inventive process for treatment of the hollow article particularly preferably includes the following steps:
i) filling of the hollow article with a material comprising or composed of one or more metallocene polyolefin waxes and/or their derivatives,
ii) treatment of the stored hollow article, and
iii) removal of the core material.

A preferred method for removal of the material comprising or composed of one or more metallocene polyolefin waxes and/or their derivatives from the hollow articles produced or treated is removal via melting and/or dissolution.

Corresponding to the inventive process, the present invention also provides the use of metallocene polyolefin waxes and/or their derivatives for production or treatment of hollow articles.

Metallocene polyolefin waxes are preferably homopolymers of ethylene or of propylene, or copolymers of ethylene or of propylene with one another or with one or more 1-olefins. 1-olefins used are preferably linear or branched olefins having from 4 to 18 carbon atoms, particularly preferably from 4 to 6 carbon atoms. Examples of these are 1-butene, 1-hexene, 1-octene, or 1-octadecene, and also styrene. In one particularly preferred embodiment of the invention, the metallocene polyolefin waxes are homopolymerized of ethylene or propylene, in particular of propylene. In another particularly preferred embodiment of the invention, the metallocene polyolefin waxes are copolymers of ethylene with propene or 1-butene. The copolymers formed from ethylene are preferably composed of from 70 to 99.9% by weight, particularly preferably from 80 to 99% by weight, of structural units derived from ethylene. Metallocene polyolefin waxes having particularly good suitability are those whose drop point is from 70 to 160° C., preferably from 100 to 155° C., and whose melt viscosity at 140° C. is from 10 to 10 000 mPa·s, preferably from 50 to 5 000 mPa·s, and whose density at 20° C. is from 0.89 to 1.20 g/cm³, preferably from 0.91 to 0.94 g/cm³.

The metallocene polyolefin waxes used in the inventive process have minimum tensile strength of 10 N/mm², with tensile strain at break of at least 2%.

They are non-transparent, or opaque, or else translucent to transparent.

If the metallocene polyolefin waxes are not processed to give moldings, it is also possible to use semifinished products, such as sheeting, pipes, or profiles composed of these polyolefin waxes.

Metallocene catalysts for preparation of the polyolefin waxes are chiral or non-chiral transition metal compounds of the formula M¹Lₓ. The transition metal compound M₁Lₓ contains at least one central metal atom M¹, to which at least one π-ligand, e.g. a cyclopentadienyl ligand, has been bonded. There may also be substituents bonded to the central metal atom M¹, examples being halogen groups, alkyl groups, alkoxy groups, or aryl groups. M¹ is preferably an element of the 3rd, 4th, 5th, or 6th main group of the periodic table of the elements, examples being Ti, Zr, or Hf. Cyclopentadienyl ligand means unsubstituted cyclopentadienyl radicals and substituted cyclopentadienyl radicals, e.g. methylcyclopentadienyl, indenyl, 2-methylindenyl, 2-methyl-4-phenylindenyl, tetrahydroindenyl or octahydrofluorenyl radicals. The π-ligands may be bridged or unbridged ligands, and simple and multiple bridges are possible here—also by way of ring systems. The term metallocene also encompasses compounds having more than one metallocene fragment, known as polynuclear metallocenes. These may have any desired substitution pattern and types of bridging. The individual metallocene fragments of these polynuclear metallocenes may either be of the same type or else differ from one another. Examples of these polynuclear metallocenes are described by way of example in EP 632 063.

Examples of general structural formula for metallocenes, and also of their activation by a cocatalyst, are found inter alia in EP 571 882.

Polar-modified metallocene waxes are also suitable.

The polar modification of these metallocene polyolefin waxes can take place via oxidation by oxygen or by oxygen-containing gases, below or above the melting point. The wax here is preferably oxidized in the melt at temperatures between the melting point of the wax and 200° C., via introduction of oxygen or of oxygen-containing gases, preferably air. The acid numbers of the waxes modified via oxidation are from 0.1 to 100 mg/KOH/g, preferably from 1 to 30 mg KOH/g, their melt viscosities, measured at 170° C., being from 5 to 10 000 mPa·s, preferably from 20 to 5 000 mPa·s, and their softening points being from 80 to 160° C. Derivatives of these oxidates are also included, for example those which can be prepared via esterification of the materials using mono- or polyhydric aliphatic or aromatic alcohols, e.g. ethanol, propanols, butanols, ethandiol, butandiols, glycerols, trimethylolpropane, pentaerythritol or benzyl alcohol. Another possibility, if partial esters are present, is further derivatization of these esters, for example via esterification with acid components, such as acrylic acid, or methacrylic acid.

Another possible method of polar modification consists in reaction of the metallocene polyolefin waxes with α,β-unsaturated carboxylic acids or with their derivatives, if appropriate in the presence of a free-radical initiator. Examples which may be mentioned of α,β-unsaturated carboxylic acids are acrylic acid, methacrylic acid, crotonic acid, and maleic acid. Examples of derivatives of α,β-unsaturated carboxylic acid are their esters or amides or anhydrides, e.g. alkyl acrylates, acrylamides, half- or diesters of maleic acid, maleic anhydride, or amides of maleic acid, e.g. maleimide, or N-alkyl-substituted maleimides. It is also possible to use mixtures of these compounds. Preference is given to maleic acid and its derivatives, and maleic anhydride is particularly preferred. The amount used of the α,β-unsaturated carboxylic acids or of their derivatives is from 0.1 to 20% by weight, based on metallocene polyolefin wax used. The preparation of these polar reaction products produced by a free-radical route is described by way of example in EP 0 941 257. The materials produced via reaction of metallocene polyolefin waxes with α,β-unsaturated carboxylic acids and with their derivatives have melt viscosities, measured at 170° C., of from 5 to 10 000 mPa·s, preferably from 10 to 5 000 mPa·s, saponification numbers of from 0.1 to 100 mg KOH/g, preferably from 2 to 80 mg KOH/g, and softening points of from 80 to 160° C., preferably from 100 to 155° C.

In one preferred embodiment, the material used in the inventive process for production of the core is composed exclusively of one or more metallocene polyolefin waxes and/or of their derivatives.

In another preferred embodiment, the material used in the inventive process for production of the core comprises at least 0.1% by weight of one or more metallocene polyolefin waxes and/or their derivatives.

In another preferred embodiment, the material used in the inventive process for production of the core is composed of one or more metallocene polyolefin waxes and/or of their derivatives, and of other substances. To the extent that other substances are present in this material, the proportion of the one or more metallocene polyolefin waxes and/or their derivatives, based on the entire material, is preferably from 0.1 to 99% by weight, particularly preferably from 10 to 95% by weight, with particular preference from 20 to 80% by weight.

The core material may also, if necessary, comprise other waxes from the group of the naturally occurring waxes, or of the partially or fully synthetic waxes. Suitable waxes have a melting point of from 40 to 160° C., preferably from 80 to 140° C., and have a melt viscosity of from 10 to 10 000 mPa·s, preferably from 500 to 5 000 mPa·s. Preferred representatives of these waxes are carnauba wax, candelilla waxes, bees wax, montan waxes, paraffins, polyolefin waxes prepared using Ziegler catalysts, and Fischer-Tropsch waxes.

Resins of natural or synthetic origin may likewise be present in the core material. Suitable resins melt in the temperature range from 40 to 200° C. and when molten have a melt viscosity of from 10 mPas up to 100 Pas. Preferred representatives are hydrocarbon resins, resins based on abietic acid, tree resins, and also synthetic resins, such as acrylic resins, ethylene-vinyl acetate resins, and also water-soluble resins, such as ethylene oxide adducts or polyvinyl alcohols.

To the extent that waxes other than metallocene polyolefin waxes, or resins, are present in the core materials, their combined proportion, based on the entire core material, is up to 99% by weight and preferably from 10 to 35% by weight.

Antioxidants may also be present in the core material. These have preferably been selected from the group of the alkane sulfonates.

To the extent that antioxidants are present in the core material, their proportion, based on the entire core material, is up to 20% by weight, and preferably from 0.5 to 3% by weight.

Pulverulent fillers insoluble in the metallocene polyolefin wax may also be present in the core material. These have preferably been selected from the group of the oxides, silicates, and organic fillers with a decomposition temperature above 180° C. and a melting point above 160° C., examples being wood flour, polystyrene, polyamide, and polytetrafluorethylene, PTFE.

To the extent that fillers of this type are present in the core material, their proportion, based on the entire core material, is up to 50% by weight and preferably from 10 to 45% by weight.

Colorant substances, e.g. pigments or soluble dyes, may also be present in the core material. These have preferably been selected from the group consisting of organic and inorganic pigments, and lipochromes.

To the extent that colorants of this type are present in the material, their proportion, based on the entire core material, is up to 20% by weight and preferably from 1 to 10% by weight.

The production of the cores, the coating of the cores, and the removal of the cores from the hollow articles are described in more detail below.

Production of the Cores:

Because the inventive core material is preferably of low melt viscosity, i.e. pourable, cores are produced by pouring the material into heat-resistant molds. The molds may be composed of metal, e.g. steel or aluminum, or else composed of suitable plastics, e.g. silicone rubber. The core material can, if necessary, also be injection-molded or extruded.

Once the core material has solidified, the core is removed. The cores are mechanically stable, and translucent, and are similar to plastic in their capability to undergo mechanical treatment.

Coating of the Core:

The finished molded core is then coated with the wall material of the subsequent component.

If the wall material is to be a plastic, thermoset systems, which may, if required, also have fiber-, texture-, or particle-reinforcement, are applied to the core surface, and are hardened under conditions specific to the material.

If the wall material is to be a metal, the core is first rendered electrically conductive, using a conductive lacquer or via incorporation of conductive fillers before production of the core material is completed, and the core is then electroplated with the desired metal.

If the core is to be used to produce a flame-resistant metal-casting mold, the core is coated via immersion in a flame-retardant molding composition, which is then hardened and is subsequently fired.

Removal of the Core:

It is not necessary in principle to remove the core from the moldings. Removal is advisable if the molding to be produced is intended to be a hollow article which remains hollow or which is, if appropriate, filled with another material, e.g. plastic or metal.

The method of removing the inventive core material is removal by melting above the melting point of the core material. Because the core material melt has low viscosity, this step is simple to execute industrially, and the core material can, if appropriate, be reused. If residue-free removal of the core material from the hollow article is intended, cleaning then takes place with an organic solvent, preferably from the group of the gasolines, if appropriate blended with toluene or xylene. This process gives complete extraction of the core material, which can, if appropriate, be reclaimed via subsequent separation from the solvent.

The present invention also provides the hollow articles produced or treated using metallocene polyolefin waxes and/or using their derivatives.

The invention is illustrated via the examples below but is not restricted thereto.

### EXAMPLE 1

### Production of a Glass-fiber-reinforced Pipe

The inventive core material, composed of a translucent PP metallocene wax (polyproylene metallocene wax) with melting point at 90° C., melt viscosity of 200 mPas, strength of 10 N/mm², with tensile strain at break of 10%, and a liquid-solid contraction of 1% was melted at 130° C. and cast in a cylindrical metal mold to give a cylindrical hollow core with wall thickness 3 mm.

A glass-fiber textile saturated with a 2-component epoxy resin was applied to the cold core. Application of a number of layers of this saturated textile-produced a wall thickness of 5 mm.

The 2-component epoxy resin system was then hardened within a period of 30 minutes at 40° C. The core was then removed, via removal by melting at 110° C.

### EXAMPLE 2

### Production of a Honeycomb-shaped Hollow Part Composed of Copper

The inventive core material, composed of a translucent metallocene PP wax with melting point of 100° C., melt viscosity of 100 mPas, strength of 15 N/mm², with tensile strain at break 10%, and liquid-solid contraction of 1% was molded by an injection-molding machine to give a honeycomb-shaped molding.

After attachment of a copper wire as contact, a metal-containing, electrically conductive layer was applied to the cooled core component.

The workpiece thus prepared was then coppered in a copper sulfate solution comprising sulfuric acid, the DC voltage applied being 3V. After 2 hours, the coppered component was isolated from the voltage source and removed from the bath. Residue-free removal of the core material was achieved via an incorporated outflow aperture at 140° C., the method being removal by melting. This gave a permeable honeycomb-like component composed of metal with wall thickness 0.15 mm.

### EXAMPLE 3

### Production of a Metal Part Via Precision Metal Casting

The inventive core material, composed of a translucent PP metallocene wax with melting point of 100° C., melt viscosity of 100 mPas, strength of 15/mm², with tensile strain at break of 10%, and liquid-solid contraction of 1% was molded by an injection-molding machine to give 10 ornamental moldings, the shot weight for each being 4 g. These individual moldings were joined to give a “tree”, by hot adhesive bonding, with prefabricated rod-shaped profiles of diameter d=4 mm composed of the inventive core material, and this tree was then immersed in a liquid water-containing molding composition composed of ethyl silicate, quartz, and clay. Once the shell thus produced had been dried and hardened, the inventive core material was removed by a melt-removal method, and the resultant hollow mold was fired at 800° C. Once the hollow mold had cooled, a metal melt composed of 750 parts of gold and 250 parts of silver was poured into this mold and cooled. Once the heat-resistant mold shell had been removed mechanically, the “metal tree” was removed and broken down to give the individual parts. The separated ornamental parts were deburred, cleaned, and polished.

### EXAMPLE 4

### Protection of a Workpiece From Vibration

The intention was to mill a longitudinal groove of width 4 mm into a tubular component with wall thickness 0.5 mm, diameter 50 mm, and length 150 mm.

To avoid deformation of the thin-walled profile via the aggression action of the milling tool, a core material based on metallocene PP wax with melting point of 90° C., tensile strain at break of 10%, and melt viscosity of 150 mPas was inserted in advance into the pipe, which was thus stabilized with respect to deformation and vibration. Once the machining had concluded, complete removal of the wax was achieved through removal by melting and subsequent cleaning with solvent.

1. A process for production of a hollow article comprising the step of using a material including one or more metallocene polyolefin waxes or one or more metallocene polyolefin wax derivatives.

2. The process for production of a hollow article, as claimed in claim 1, further comprising the steps of:
i) molding of a core composed of the material and
ii) applying one or more solids to at least a portion of the core.

3. The process for production of a hollow article, as claimed in claim 1, wherein the hollow article is selected from the group consisting of hollow metallic components, fiber- or particle-reinforced plastics parts, and metal-casting molds.

4. The process for production of a hollow article, as claimed in claim 1, wherein the hollow article is a fiber- or particle-reinforced plastics part, and the material is expandable.

5. The process for production of a hollow article, as claimed in claim 1, wherein the hollow article is a hollow metallic component, and the material is a binder for production of conductive coatings.

6. The process for production of a hollow article as claimed in claim 1, wherein the article is a metal-casting mold, and the process further comprises coating the material by immersing the material in a flame-retardant molding composition to form a coated material, hardening the coated material and firing the coated material.

7. The process for production of a hollow article, as claimed in claim 1, wherein the material is used together with at least one other substance selected from the group consisting of natural waxes, synthetic waxes, natural resins and synthetic resins.

8. (canceled)

9. (canceled)

10. The process for production of a hollow article, as claimed in claim 2, further comprising removing the material from the hollow article after the production of the hollow article.

11. The process for production of a hollow article, as claimed in claim 10, wherein the removing step further comprises removing the material from the hollow article by melting, dissolution or a combination thereof.

12. A hollow article made in accordance with the process of claim 1.

13. A process for treatment of a hollow article comprising the step of using a material including one or more metallocene polyolefin waxes or one or more metallocene polyolefin wax derivatives.

14. The process for treatment of a hollow article, as claimed in claim 13, further comprising:
i) filling the hollow article with the material to form a stored hollow article, and
ii) treating the stored hollow article.

15. The process for treatment of a hollow article, as claimed in claim 14, wherein the treating step further comprises a mechanical treatment.

16. The process for treatment of a hollow article, as claimed in claim 13, further comprising removing the material from the hollow article after the treatment of the hollow article.

17. The process for treatment of a hollow article, as claimed in claim 16, wherein the removing step further comprising removing the material from the hollow article by melting, dissolution or a combination thereof.

18. A hollow article made in accordance with the process of claim 13.
